(19) United States
(12) Patent Application Publication
(10) Pub. No.: US 2019/0139428 A1
(43) Pub. Date: May 9, 2019

(54) Emotional Artificial Intelligence Training

(71) Applicant: Science Applications International Corporation, McLean, VA (US)

(72) Inventor: Robert N. Hatton, Hunstville, AL (US)

(21) Appl. No.: 16/171,039

(22) Filed: Oct. 25, 2018

Related U.S. Application Data
(60) Provisional application No. 62/577,421, filed on Oct. 26, 2017.

(51) Int. Cl. G09B 5/08; G09B 19/00

(52) U.S. Cl. CPC G09B 5/08; G09B 19/00

(57) ABSTRACT

Physical reactions of students may be monitored during a first training lesson, and the physical reactions may be used to determine the depth of learning, whether and when a second training lesson should be presented to the students. The type and/or timing of the second training lesson can be based on biometric scores obtained based on student physical reactions such as facial expressions, Galvanic skin response, and heart rate variability. The biometric scores may be used to modify test scores associated with the students and the first training lesson, in order to determine the type and/or timing of the second training lesson.

### CROSS-REFERENCE TO RELATED APPLICATIONS

The present application is a non-provisional application claiming priority to U.S. Provisional Application No. 62/577,421, filed Oct. 26, 2017, and entitled “Emotional AI Training,” the contents of which are hereby incorporated by reference.

### BACKGROUND

Trainers and organizations across all industries are keenly focused on delivering engaging products and/or services that effectively achieve training goals, and although the increased availability of technology can make training easier in some respects, that increased technology can also result in sophisticated systems that require a high level of proficiency to operate. Developing and maintaining a properly-trained workforce can be an ever-present challenge.

### SUMMARY

A student's emotional state during a lesson (e.g., being happy, attentive, fearful, angry, etc.) can provide insight into how well the student will retain the information they have learned during the lesson and the depth of their understanding (so-called cognitive depth). Features described herein relate generally to the use of biometrics in an educational system to help determine whether, and when, remedial and/or refresher lessons may be desirable to complement the teachings of an initial training session.

Biometric sensors, such as facial expression detection systems, pupil/iris detection systems, heart rate monitoring systems, Galvanic skin response sensors, blood pressure sensors, and/or others may be used to monitor a student's physiological reactions during a training lesson. The biometric responses may be processed to identify certain kinds of human emotional reactions, such as anger, fear, disgust, sadness, vigilance, etc., and those emotional reactions may be processed to generate a biometric score, such as a cognitive depth factor (CDF), indicating the student's overall training emotional state for the lesson.

A post-lesson test may also be administered to the student, asking the student to answer questions regarding the subject matter of the lesson. The student's score on that test may be adjusted using the biometric score to result in a strength of learning (SoL) score for the student, and the SoL score may be used to determine whether further instruction is warranted and when refresher training should be scheduled.

An expected rate of learning decay may be determined for the lesson, to anticipate the likelihood of a student forgetting what he/she learned during the lesson. This decay rate may be based on a variety of factors, such as the complexity of the lesson, the number of tasks involved in the lesson, etc. The student's SoL score may then be projected to decay based on the expected rate of cognitive decay, and further refresher lessons may be scheduled accordingly.

The above is merely a summary of various features described herein, and is not intended to limit this patent's scope or be an exhaustive listing of all the novel details.

### BRIEF DESCRIPTION OF THE DRAWINGS

FIG. 1 illustrates an example sequence of training lesson screens and corresponding student emotional states.

FIG. 2 illustrates example hardware elements for implementing the various features described herein.

FIG. 3 illustrates an example table showing various emotion metrics and their corresponding ranges.

FIG. 4 illustrates an example algorithm for biometric-based training.

FIG. 5 illustrates example biometric score (e.g. cognitive depth factor (CDF)) tables for a variety of metrics.

FIG. 6 illustrates example biometric scoring for two example student learners.

FIG. 7 illustrates an example analysis of the biometric scoring from FIG. 6.

FIGS. 8a&b illustrate example learning decay curves.

### DETAILED DESCRIPTION

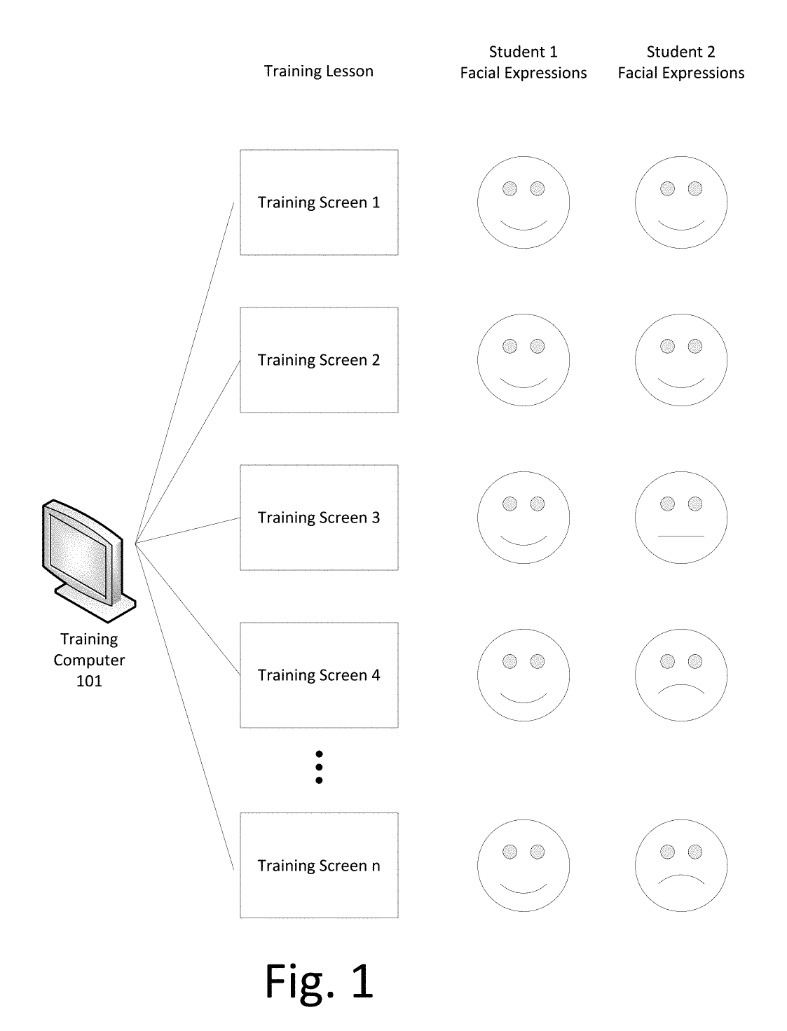

As generally illustrated in FIG. 1, two students may view a training lesson on one or more training computers 101. The lesson may be for any type of training subject matter, such as learning how to operate a piece of machinery or computing system, learning procedures for handling different kinds of customer inquiries, learning how to diagnose problems in an automobile, etc. The lesson itself may comprise a series of training screens 1 . . . n, each of which may provide the student with information pertinent to the lesson. Screens are just an example, and other forms of media, such as audio, may also or alternatively be included in the training.

The students may exhibit different kinds of facial expressions throughout the lesson, which may be indicative of the students' emotional reactions. As illustrated in FIG. 1, Student 1 exhibits a relatively constant smile throughout the various screens in the lesson, which may indicate a happy state. Student 2, however, struggles a bit. Student 2's smile remains for screens 1 and 2, but by training screen 3, the student's facial expression begins to change, and the student frowns for the duration of the lesson from screens 4 through n.

Even if both students are able to accurately answer questions about the training subject matter immediately after the lesson (e.g., via a post-lesson quiz about how to operate a piece of machinery), it is expected that Student 1 will actually retain and apply the subject matter more effectively than Student 2. Biases in testing methodologies may allow a student to correctly guess the answer to a question without understanding the answer, and these biases may be offset by using biometric sensors and computing a biometric score indicating the student's cognitive depth of learning for the lesson. The differences in their emotional state during the lesson may indicate that Student 2 may have experienced more anxiety and/or stress during the lesson, which may mean that Student 2's depth of learning was not as deep as Student 1, and that Student 2 may need a refresher course before Student 1 will. It is hypothesized that people tend to do a poorer job at learning when under stress or anxiety. Various features described herein may obtain and use emotional state information, obtained by monitoring facial expressions and other biometric information, to provide a training plan that can effectively schedule remedial and/or refresher training to help keep students trained.

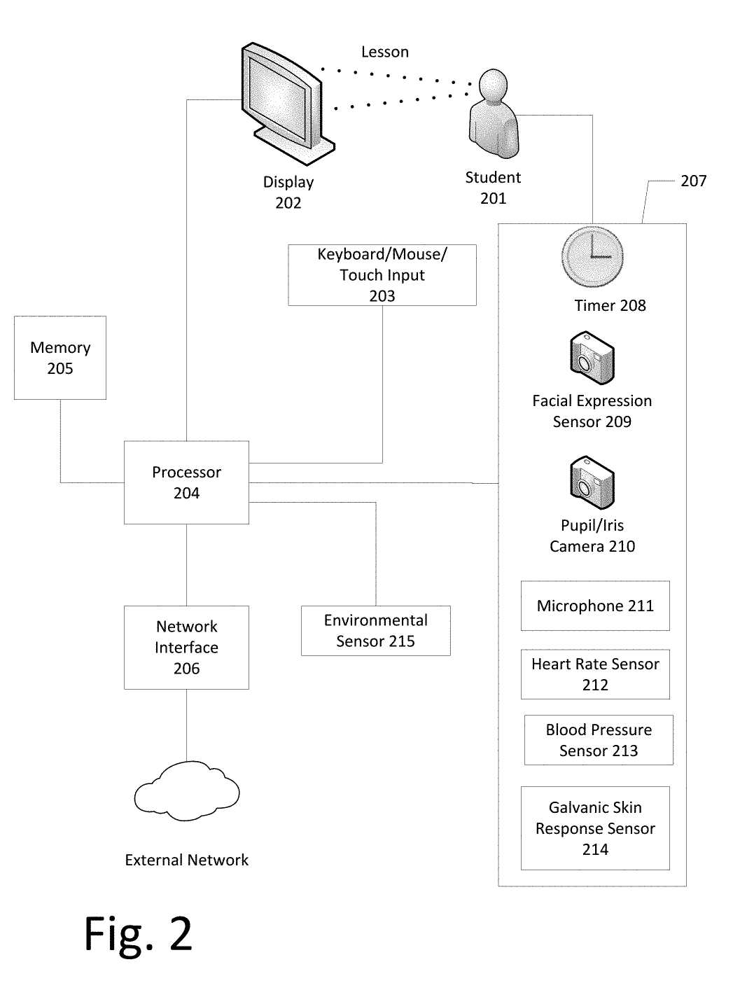

FIG. 2 illustrates an example system that can be used to implement the various features described herein. As a general matter, the examples in FIG. 2 are merely examples. Individual components may be implemented and/or duplicated using several components, separate components may be integrated, and components may be rearranged, augmented, and/or omitted as desired.

A student 201 may observe training screens on a display 202 (audio may be provided via speakers, not shown), and may provide user input (e.g. navigating a training screen, answering questions, etc.) on a user input device 203. User input device 203 may be any type of input device, such as a keyboard, mouse, touch-sensitive display, game controller, head-tracking device, etc. The lesson may be controlled by a processor 204 that may be executing computer-readable instructions of a training program stored in memory 205 and/or obtained from a remote source via a network interface 206. Any type of memory 205 may be used, such as random access memory (RAM), read-only memory (ROM), optical or magnetic disk, solid-state drive (SSD), flash drive, etc., and the network interface 206 may connect to any desired type of wired (e.g., Ethernet, coaxial cable, fiber optic, etc.) or wireless (e.g., wi-fi, cellular, BLUETOOTH, IEEE 802.11, etc.) network to reach remote sources that may be located anywhere in the world. The processor 204, memory 205, display 202, and user input 203 may be used to implement a computing device to perform the various features described herein, and to implement any of the various elements described herein.

Biometric sensors 207 may be communicatively coupled to the processor 204 (e.g., Universal Serial Bus (USB) connection, Ethernet, wireless connections, etc. may all be used to communicatively connect the elements as shown in FIG. 2), and may provide various types of measurements and feedback that can be used to estimate the student's 201 emotional state during the training lesson. A timer 208 may be used to indicate progress through the lesson, and to cause one or more of the sensors 207 to provide a biometric report to the processor 204 at predetermined points in the lesson (e.g., at predetermined training screens, multiple times each second, once every 30 seconds, etc.). The report may comprise emotional state information about the student 201, along with timing information to correlate the emotional state with the portion of the training lesson (e.g., a training screen, playback time point, chapter, etc.) that was being shown when the emotional state was observed.

The biometric sensors 207 may comprise one or more facial expression sensors 209. A facial expression sensor may comprise one or more cameras positioned to capture images of the student's 201 face, and may analyze the images to detect motion of the user's facial muscles, eyebrows, eyes, mouth, etc., and may report the results of such analysis to the processor 204. The facial expression sensor 209 may be implemented using the AFFDEX market research system from Affectiva. The AFFDEX system may employ one or more cameras observing a student's 201 face, and may analyze the face to detect facial expressions and corresponding emotions. The system may then provide a report to processor 204, indicating various types of emotions that were detected in the images captured by the one or more cameras.

The biometric sensors 207 may comprise one or more pupil/iris cameras 210. The pupil/iris camera(s) 210 may capture one or more images of the student's 201 eyes, and measure dilation of the pupils and/or movement of the iris in the eyes. Such dilation and/or movement may be used to assess the student's 201 emotional state.

One or more microphones 211 may be used to detect the student's 201 voice, and the voice may be used to assess the student's 201 emotional state. For example, a quivering or soft voice may indicate a lack of confidence in a particular answer.

One or more heart rate sensors 212 may be used to detect the student's 201 heart rate. A rise in heart rate may indicate nervousness, while a calm, steady heart rate may indicate confidence. The heart rate sensor 212 may also report heart rate variability, or the differences in time between successive heartbeats. Heart rate variability (HRV) tends to decrease during stressful situations, and is correlated to the autonomic system response to stress.

One or more blood pressure sensors 213 may be used to monitor the student's 201 blood pressure. Blood pressure may increase under stress, and this can be a further indicator of the student's experience during the training.

One or more Galvanic skin response sensors 214 may be used to measure the student's 201 Galvanic skin response (GSR). The GSR may measure the electrical characteristics in the student's 201 skin, and changes in those characteristics can be used to determine the student's 201 emotional state. Under stress, a person's GSR will tend to increase, and that increased GSR may indicate that the student is having more difficulty with the training.

In addition to the biometric sensors 207, there may also be one or more environmental sensors 215. The environmental sensors 215 may record various aspects of the environment in which the student is taking the training lesson. An air quality sensor may detect smells that were in the air at various points in the training. A thermometer may measure the air temperature in the training room, and report the temperature at different points in the training session. A light sensor may detect brightness of the lights in the room, and report that information. A location detection system, such as a global positioning system (GPS), may record a physical location of the training lesson, and report that as well. Environmental sensors may be used to record all environmental conditions in the training lesson, and this information may also be reported and used to assess the student's 201 effectiveness in learning.

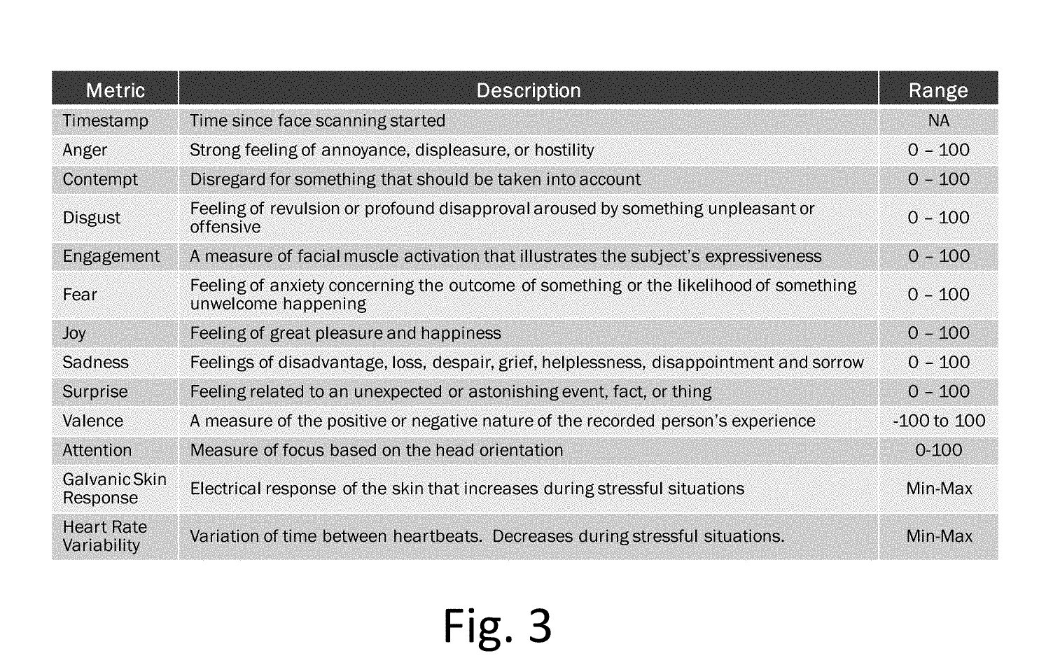

These and other types of sensors may be used in the system, and may periodically report their results to the processor 204. FIG. 3 illustrates an example table of the types of emotional state data that can be reported by the biometric sensors 207 (and/or which may be determined after the processor 204 analyzes raw measurement data provided by the biometric sensors 207). The FIG. 3 example shows several emotional metrics being reported:
Anger—A strong feeling of annoyance, displeasure, or hostility;
Contempt—Disregard for something that should be taken into account;
Disgust—Feeling of revulsion or profound disapproval aroused by something unpleasant or offensive;
Engagement—A measure of facial muscle activation that illustrates the subject's expressiveness;
Fear—Feeling of anxiety concerning the outcome of something or the likelihood of something unwelcoming happening;
Joy—Feeling of great pleasure and happiness;
Sadness—Feelings of disadvantage, loss, despair, grief, helplessness, disappointment, and sorrow;
Valence—A measure of the positive or negative nature of the recoded person's experience;
Attention—Measure of focus based on the head orientation;
Galvanic Skin Response (GSR)—Electrical response of the skin that increases during stressful situations; and
Heart Rate Variability (HRV)—Variation of time in between heartbeats. Decreases during stressful situations.

Some of the metrics are shown on a scale of 0-100 (or −100 to +100, in the case of Valence), which corresponds to scaling information provided by the AFFDEX system noted above. Others are shown on a scale of measured data. For example, the GSR may be expressed in units of conductance, such as 1/μOhms or (μΩ)⁻¹, while the heart rate variability (HRV) may be measured in units of time, such as milliseconds.

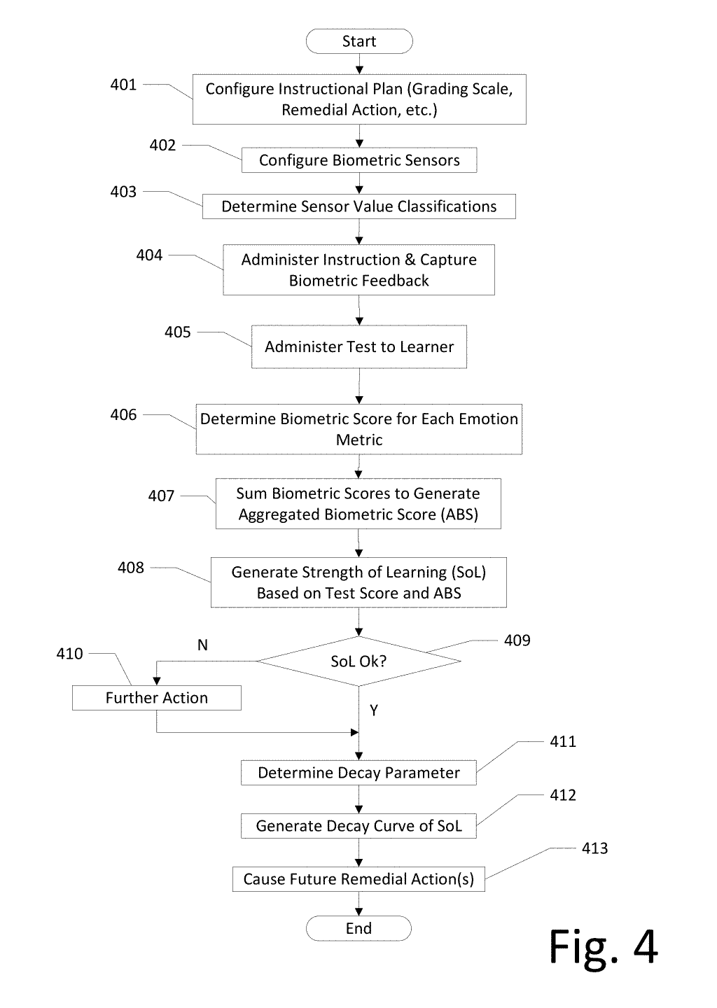

Each of the metrics shown in FIG. 3 may be processed to result in an individual contribution to the student's 201 overall biometric score. The degree of detected Anger may result in a first biometric score contribution; the degree of detected Contempt may result in a second biometric score contribution; etc. Other and/or alternative sensor metrics may be reported as well for other types of biometric responses and other kinds of emotions, as the above are merely examples. These examples, and their use, are described further below in the algorithm shown in FIG. 4.

FIG. 4 illustrates an example algorithm that may be performed, for example, by the processor 204 by executing instructions from the memory 205. The various steps are illustrated for convenience of explanation, and need not necessarily be performed in the order depicted. Indeed, the various steps may be rearranged, divided, combined, omitted, and/or otherwise modified as desired in implementation. The illustrated steps may be performed by a computing device, such as the processor 204 and/or device shown in FIG. 2, executing instructions stored in computer-readable media, such as memory 205.

In step 401, an initial instructional plan may be developed (or received, such as in a transmission from remote source via interface 206) and stored in memory 205. The instructional plan contents may vary depending on the subject matter to be learned. A plan for learning how to operate a piece of machinery might include lessons on the basic components of the machine, maintaining different parts of the machine, and separate lessons for each of several different tasks for which the machinery might be used. For each such lesson, there may be a grading scale correlating a student's performance with further training action. As noted above, a strength of learning (SoL) value may be determined for a student after a particular lesson and based on the student's emotional reactions during the lesson. The grading scale for the lesson might indicate levels of proficiency based on the SoL, and consequences for the student achieving that level. For example, a lesson on operating a forklift might have the following SoL scale:

| SoL | |
|---|---|
| Score | Consequence |
| >90 | Excellent, no further training needed at this time |
| 80-89 | Good; suggest optional additional training |
| 70-79 | Fair; require additional training lesson |
| <70 | Fail; require student to retake training lesson |

A student achieving a particular SoL score, such as 71, may result in further training action as indicated in the scale. For the example of an SoL score of 71, that student's SoL may be designated as fair, and one or more additional training lessons may be scheduled for the student. The additional training lessons need not be a complete copy of the original training, and may instead be a shorter version that addresses particular areas that the student may have struggled with. These particular areas may be determined based on the results of an examination administered to the student during or after the lesson (e.g., correlating incorrect answers with particular follow-up lessons). A student scoring 53, however, might be required to retake the entire training lesson. Or, if desired, an alternative training lesson may be administered to the student, covering the same comprehensive subject matter as the original lesson.

In step 402, the various biometric sensors 207 may be configured. This may entail physically attaching electrodes to the student 201, installing facial recognition cameras and associated software, setting the timer 208 value for frequency of reporting, and any other setup needed for the various sensors being used.

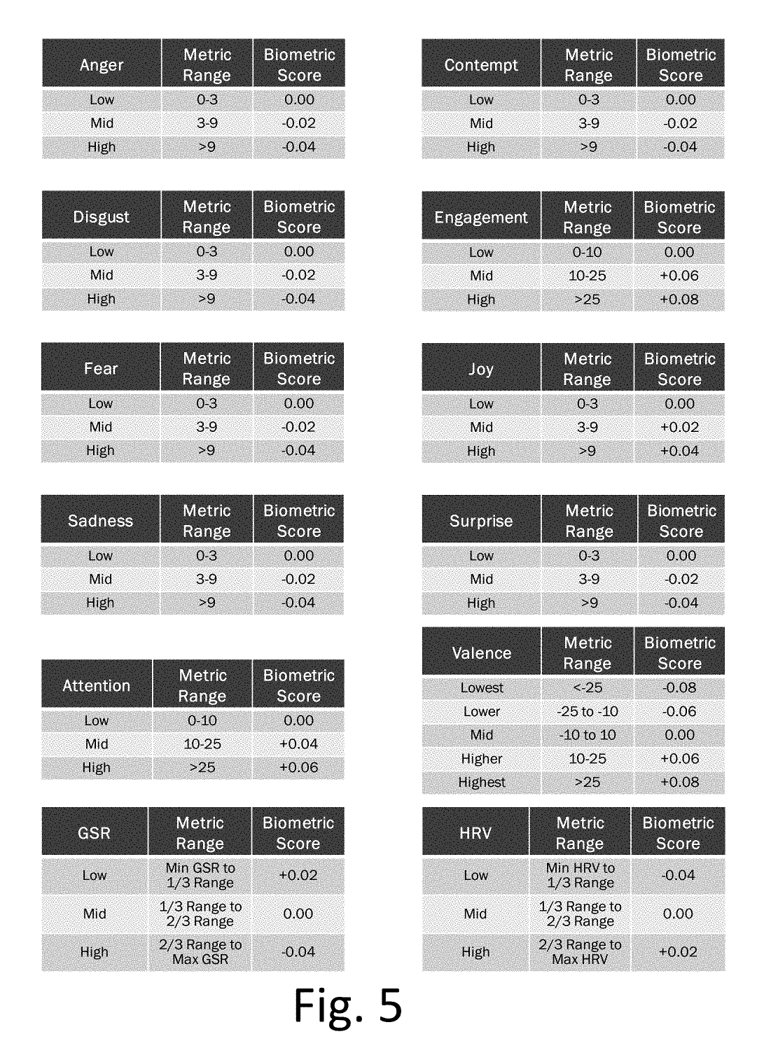

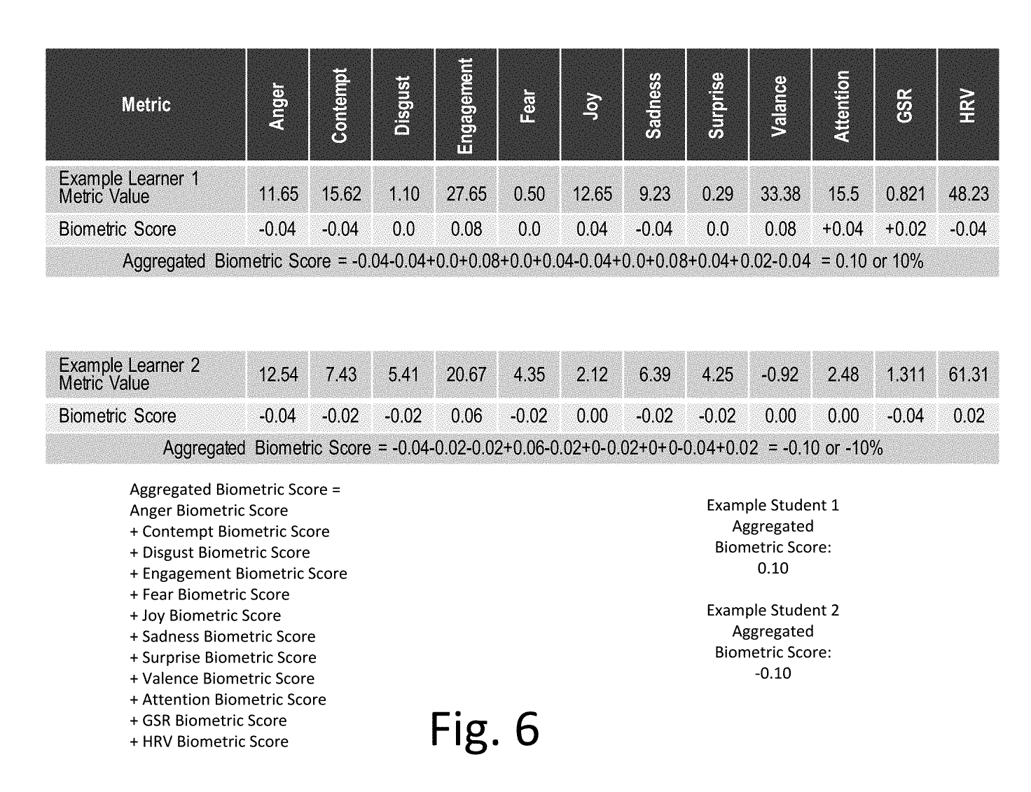

In step 403, various sensor metric classifications may be determined. These classifications will be used to determine the biometric score contribution from each of the metrics reported above (Anger, Contempt, etc.). FIG. 5 illustrates several tables indicating how the various sensor metrics may be translated to a biometric score. For example, the Anger emotion, which may be reported on a scale of 0-100 by the AFFDEX system, may be broken down into different biometric score contributions depending on the degree of anger that was detected. If there is very little anger detected, then the Anger metric might be in the range of 0-3, and the biometric score for the Anger metric may simply be 0.00. If, however, a small amount of Anger was detected, in the range of 3-9 (on the scale of 0-100), then a biometric score of −0.02 may be assigned to the Anger metric. If a larger amount of Anger was detected, in the range of 9-100, then an even more significant biometric score, −0.04, may be assigned to the Anger metric. The numeric values used herein are merely examples, and any alternative scale and/or classification may be used. Additionally, the illustrated scales may overlap (e.g., a value of 3 for Anger may appear in both the “Low” and “Mid” ranges), and in an example, a value falling on an overlap may simply revert to the middle range by default.

Similar treatment may be used for the other metrics, although different biometric scores might be provided. In the FIG. 5 example, the Engagement metric is shown with different scaling from the Anger metric discussed above. If Engagement is reported in a range of 0-10, then no (or 0.00) biometric score will result from the Engagement metric. However, if Engagement is in the range of 10-25, the biometric score for this metric might be +0.06, and if the Engagement metric is reported to be greater than 25, then a larger biometric score of +0.08 may be assigned to this metric.

The biometric scores are not limited to 3 ranges for a given metric, and any desired number of ranges may be used. In the FIG. 5 example, the Valence metric is shown as having five (5) tiers, each with its own range and its own corresponding biometric contribution score.

The ranges are also not limited to the 0-100 scale, and some metrics may instead be based on different data. For example, as shown in FIG. 5, the Galvanic Skin Response (GSR) can be classified based on minimum and maximum GSR values measured for the student 201. These min/max values may be measured over a period of time (indeed, all of the metrics above may be periodically, e.g., every 30 seconds, reported based on the timer 208, and the metric values used may be a median of the reported values of the particular metric). A reported GSR metric that is on the low end, between a minimum reported GSR value for the student 201 and ⅓ of a range between the minimum and maximum values, might be assigned a biometric score of +0.02. A reported GSR metric that is between ⅓ and ⅔ of the range between the minimum and maximum values may be assigned a CDF score of 0.00, and a reported GSR metric that is between ⅔ of the range and the maximum may be assigned a biometric score of −0.04. To illustrate, if a dozen GSR reports were received over the course of a student's 201 lesson, and the GSR reports ranged from 0.00 to 3.00 (μΩ)⁻¹, then the minimum GSR would be 0.00 (μΩ)⁻¹, the maximum GSR would be 3.00 (μΩ)⁻¹, and the range between would be 3.00 (μΩ)⁻¹. The three bands of biometric scores for the GSR would then be: Low Band) between 0.00 and 1.00; Mid Band) between 1.00 and 2.00; and High Band) between 2.00 and 3.00. As noted above, values falling on a boundary (e.g., 1.00) between ranges may be determined to be in the middle range (e.g., between 1.00 and 2.00).

The Heart Rate Variability (HRV) metric may have similar ranges defined by ⅓ of the reported range between minimum and maximum HRV, although the resulting biometric score is reversed (−0.04 for the low end and +0.02 on the high end) since HRV tends to act in the opposite manner from GSR. The GSR tends to increase during stressful situations, and the HRV tends to decrease during stressful situations.

In step 404, the student 201 may engage in the training session. The student 201 may view the various training screens, and the biometric sensors 207 may periodically report the metrics discussed above. The metrics may be reported once for each training screen, periodically according to the timer 208 (e.g., once every 30 seconds), and/or at any other desired interval or event.

The various reported metrics above will be processed in conjunction with a baseline test score from the student. In step 405, the training system may administer a test to the student 201 to assess the student's 201 understanding of the training materials after the lesson. The test may ask the student 201 to answer various questions pertaining to the subject matter of the training session, and the student's 201 answers may be scored on a percentage scale. The test 405 may be administered during the presentation of the various training screens (e.g., interspersed throughout the lesson), and/or the test 405 may be administered after the conclusion of the training screens. The use of the test score will be discussed further below.

In step 406, a biometric score may be determined for each of the metrics reported in step 404. This may be accomplished using the tables shown in FIG. 5, and FIG. 6 shows example results for two students, Student 1 and Student 2. In the FIG. 6 example, Student 1's median Anger metric (e.g., taken from a plurality of reports received in step 404) is 11.65 (on the scale of 0-100 discussed above). From the Anger table in FIG. 5, an 11.65 metric value translates to a biometric score of −0.04, and that is reflected in the table in FIG. 6. For Student 1's median Contempt score of 15.62, the corresponding biometric score is −0.04. Similar processing may be performed for each of the metrics, for both Student 1 and Student 2.

In step 407, and for each student 201, the various metric biometric scores may be added together, to result in an aggregated biometric score (ABS) that, as noted above, may indicate the student's cognitive depth of learning the subject matter in the lesson. As shown in FIG. 6, the sum total of the biometric scores for Student 1 results in an aggregated biometric score of +0.10, and for Student 2 the aggregated biometric score is −0.10. These aggregated biometric scores may represent the aggregated emotional effects of the various metrics discussed above. Student 1's aggregated biometric score is higher than Student 2's aggregated biometric score, and this indicates that Student 1 may have absorbed the material more effectively than Student 2.

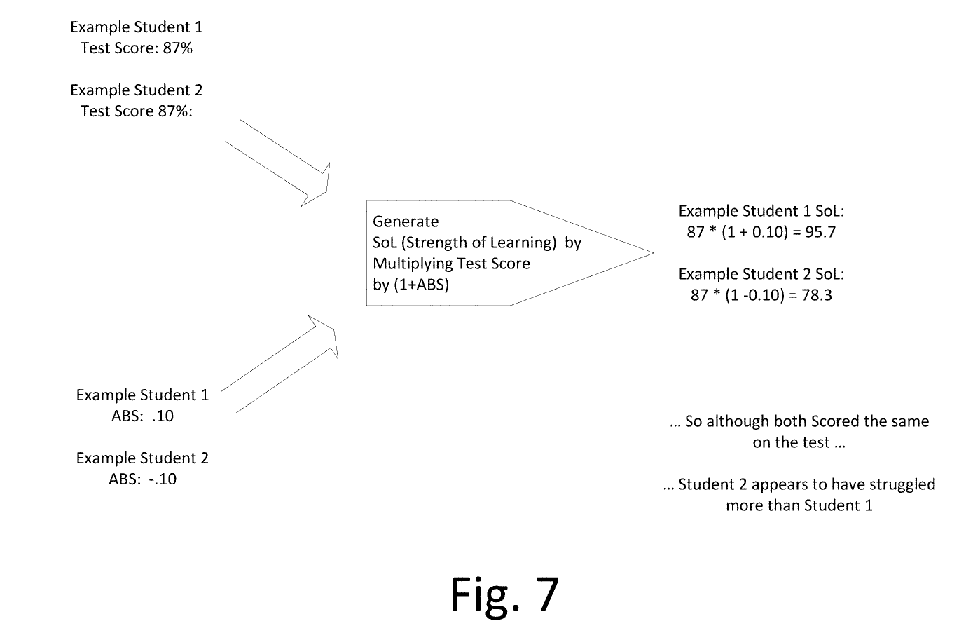

In step 408, a Strength of Learning (SoL) score may be determined for each student based on their aggregated biometric scores. FIG. 7 illustrates this determination. The SoL score may be determined by multiplying the student's test score (from step 405) by (1+ABS), where ABS is the aggregated biometric score determined in step 407. So, for example, if both Student 1 and Student 2 achieved a score of 87 in the test 405, then the SoL for Student 1 would be: 87*(1+0.10)=95.7, while the SoL for Student 2 would be: 87*(1-0.10)=78.3. With these adjusted test scores, it is apparent that although both Student 1 and Student 2 scored the same on the test (each getting an 87 percent), Student 1 appears likely to have better absorbed the information from the lesson.

In step 409, the student's 201 score may be evaluated to determine whether the student 201 has performed to a satisfactory degree. The grading scale from step 401 may be consulted to determine what, if any, further action should be taken for the student. If further action is deemed necessary, then such action may be taken in step 410. For example, the student may be directed to a supplemental training lesson, or to repeat the previous training lesson, for remedial training to improve their mastery of the subject. Such a second training lesson may be executed by the processor 204 following an initial training lesson.

The student's SoL score, and mastery of the subject matter of the training, may be expected to decay over time. Steps 411-413 may be used to generally address this decay. In step 411, a learning decay rate parameter for the subject matter of the training lesson may be determined. Proficiency in different subject matter may be expected to decay at different rates. This may be due to a variety of factors, such as complexity of the subject matter, the number of tasks trained in the subject matter, the level of knowledge required for the tasks in the subject matter, the level of decisionmaking and/or execution in the tasks, the frequency of expected use of the elements in the lesson, a taxonomy of lesson complexity (e.g., Bloom's Taxonomy from Krathwohl, D., Bloom, B., and Bertram, B. (1973). Taxonomy of Educational Objectives, the Classification of Educational Goals. Handbook II: Affective Domain, David McKay Col., New York), etc. In general, a student's proficiency in the subject matter, at a number of weeks (y) after the lesson, can be expressed as an exponential function of the original SoL:

Proficiency at y weeks=SoL×e^{(-y/s)},
where (s) is a learning decay rate parameter for the lesson, and
(e) is Euler's constant (approx. 2.71828).

The table below shows an example assignment of learning decay rates parameters to a variety of lesson types, based on their Bloom Taxonomy Level, number of tasks trained, and level of demands for knowledge, decision, and execution:

| | | Level of Task | |
|---|---|---|---|
| | | Demands for | |
| | | Knowledge, | |
| Bloom's | Number of Tasks | Decision, and | Learning |
| Taxonomy | Trained (High, | Execution (High, | Decay Rate |
| Level (1-8) | Moderate, Low) | Medium, Low) | Parameter (10-50) |
| 6-8 | High | High | 10 |
| 4-6 | Moderate | High | 20 |
| 4-6 | Moderate | Medium | 30 |
| 4-6 | Moderate | Low | 40 |
| 1-4 | Low | Low | 50 |

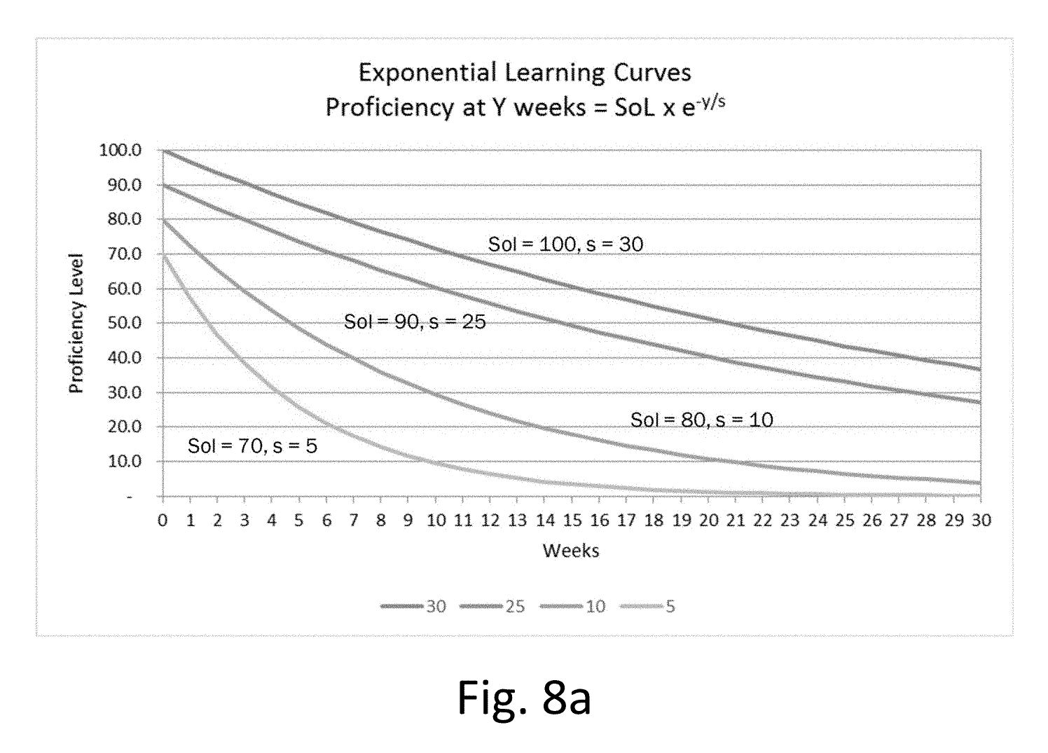

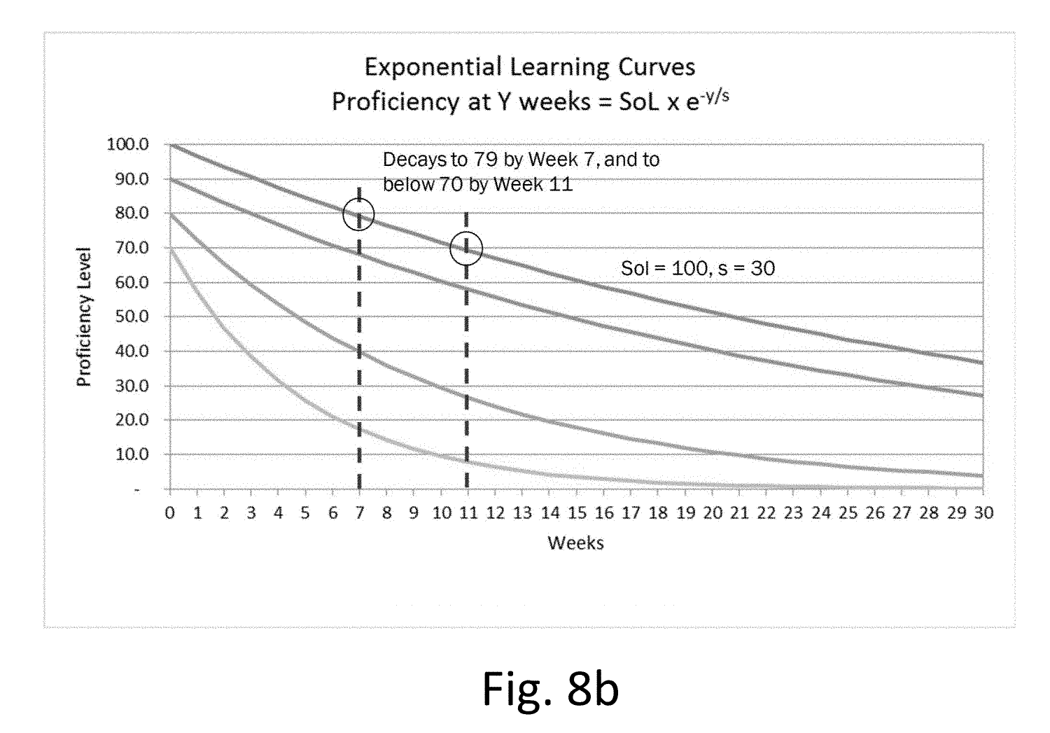

In step 412, a learning decay curve may be generated for the student, based on the student's SoL and the lesson's learning decay rate parameter (s). FIG. 8a illustrates a number of example learning decay curves for four (4) students: one having an SoL of 100 and a learning decay rate parameter (s) of 30; one having an SoL of 90 and a learning decay rate parameter (s) of 25, one having an SoL of 80 and a learning decay rate parameter (s) of 10, and one having an SoL of 70 and a learning decay rate parameter (s) of 5. The curves indicate predicted levels of proficiency, in terms of a reduced SoL, as weeks pass after the lesson is taken by each of these students. Using this curve, the system may determine when a student's SoL is expected to reach a threshold performance level at which remedial action (e.g., a refresher course) should be taken. In the example instructional plan discussed above in step 401, an SoL Score of 79 or lower results in a required additional training lesson or retaking the original training lesson. Using the uppermost example curve in FIG. 8a (SoL=100, s=30), and as shown in FIG. 8b, that student's SoL is expected to decay from 100 to 79 by the seventh week. Accordingly, that student may be scheduled for another training lesson shortly before that seventh week.

In step 413, one or more future remedial actions may be executed by the processor 204. For example, a second training lesson may be executed at a scheduled future time. If the scheduled action is taken at the scheduled time (e.g., the student takes the second lesson at the scheduled time), then the student's SoL may be reset to a new value based on the new lesson. If the scheduled action is not taken on time, and if the student's SoL decays even further, then alternative remedial actions may be taken. The instructional plan may identify a plurality of different executable training lesson programs, and corresponding SoL scores that serve as thresholds indicating when the training lesson program should be executed (or scheduled for execution). For example, in the sample instructional plan above, an SoL of 70-79 merely requires additional training (which may be, for example, a short supplemental training course), while an SoL below 70 may require the student to retake the training altogether (e.g., starting over from the beginning with the longer, more comprehensive original training course). If the student's SoL is expected to decay to 79 by the seventh week, and then further to below 70 by the eleventh week, then if that student does not take the scheduled refresher course before the eleventh week, then the student may be rescheduled for a complete retake instead of the refresher course. FIG. 8b illustrates these example points on the student's learning decay curve.

The examples in FIGS. 3-6 illustrate only one example set of metrics and their usage. Other variations may be made, using different sets of metrics, different CDF banding and scoring, etc. For example, some additional metrics that may be used include:
a. the environmental factors noted from environmental sensors 215 above;
b. Engagement metrics such as:
   i. Time spent by a student on a particular page or training screen
   ii. the student's 201 start and/or stop patterns in taking the lesson
   iii. learning paths such as alternative data sources, mini-games, seminars, etc.
   iv. course navigation profile
c. Learning metrics such as:
   i. pre-test and post-test scores
   ii. answer patterns indicating lack of confidence or tendency to guess
   iii. effectiveness of adaptive learning approaches
   iv. self-reported interest/expertise in subject matter
d. Cognitive metrics such as:
   i. self-reported confidence
   ii. level of mastery demonstrated by knowledge checks/testing
   iii. depth of learning measured by brain triggers ISD assessments
   iv. learning decay measured by deep encoding assessment

The various features described above are merely examples. The components and steps discussed above may be combined, divided, rearranged, augmented, omitted, and/or other otherwise changed without necessarily departing from the scope of that described herein. This patent should be limited only by the claims that follow.

I claim:

1. A method comprising:
monitoring a plurality of physical responses of a student during a first training lesson;
determining, by a computing device and based on the physical responses, a plurality of biometric scores corresponding to a plurality of different emotional responses;
aggregating the plurality of biometric scores;
using the aggregated biometric scores to modify a test score associated with the student and the training lesson; and
causing, based on the modified test score, presentation of a second training lesson to the student.

2. The method of claim 1, wherein the causing the presentation of the second training lesson is based on modifying the test score based on one or more facial expressions detected from the student during the first training lesson.

3. The method of claim 2, wherein the modifying the test score is further based on a degree of anger detected in the one or more facial expressions.

4. The method of claim 1, wherein the causing the presentation of the second training lesson is based on modifying the test score based on a Galvanic skin response of the student measured during the first training lesson.

5. The method of claim 1, wherein the causing the presentation of the second training lesson is based on modifying the test score based on heart rate variability of the student measured during the first training lesson.

6. The method of claim 1, wherein the aggregating the plurality of biometric scores comprises summing biometric scores for a degree of attention, an amount of heart rate variability, and a Galvanic skin response.

7. The method of claim 1, wherein the monitoring the plurality of physical responses comprises capturing a plurality of facial expressions of the student at different points in the first training lesson.

8. The method of claim 7, wherein the monitoring the plurality of physical responses comprises capturing a facial expression for each of a plurality of training screens in the first training lesson.

9. The method of claim 1, wherein the causing the presentation of the second training lesson comprises causing the presentation of the second training lesson at a time that is scheduled based on a predicted learning decay associated with the student and the first training lesson.

10. The method of claim 9, further comprising determining the predicted learning decay based on:
the modified test score; and
a complexity of the first training lesson.

11. A method comprising:
receiving, by a computing device, a test score associated with a student and a first training session;
modifying the test score based on:
one or more facial expressions made by the student during the first training session;
a Galvanic skin response of the student during the first training session; and
heart rate variability of the student during the first training session; and
causing, based on the modified test score, presentation of a second training session to the student.

12. The method of claim 11, wherein the causing the presentation of the second training session is further based on a plurality of biometric scores that are based on the one or more facial expressions.

13. The method of claim 12, wherein the plurality of biometric scores comprises different biometric scores for a plurality of different emotions.

14. The method of claim 11, wherein the causing the presentation of the second training session occurs at a time that is based on a predicted learning decay of the modified test score.

15. The method of claim 11, further comprising scheduling, based on the modified test score and a complexity of the first training session, the presentation of the second training session.

16. The method of claim 11, wherein the modifying the test score comprises aggregating biometric scores that are based on:
the one or more facial expressions,
the Galvanic skin response, and
the heart rate variability.

17. A method comprising:
receiving test scores indicating performance, by a plurality of students, on a test associated with a first training lesson;
generating, for the students, expected learning decay curves that are based on the test scores and on one or more physical reactions measured of the students during the first training lesson;
determining, for each of the students, a future time when a learning decay curve of the student reaches a performance threshold; and
causing, based on the future time for each of the students, presentation of a second training lesson that is associated with the first training lesson.

18. The method of claim 17, wherein the generating the expected learning decay curves is further based on facial expressions detected from the students during the first training lesson.

19. The method of claim 17, wherein the generating the expected learning decay curves is further based on aggregated biometric scores that are based on heart rate variability values detected from the students during the first training lesson.

20. The method of claim 17, wherein the generating the expected learning decay curves is further based on aggregated biometric scores that are based on Galvanic skin responses detected from the students during the first training lesson.
